(19) United States
(12) Patent Application Publication
(10) Pub. No.: US 2026/0286923 A1
(43) Pub. Date: Sep. 24, 2026

(54) FUEL INJECTOR HAVING FUEL PLUNGER WITH ENERGIZED SEALING ELEMENT AND METHOD

(71) Applicant: Caterpillar Inc., Peoria, IL (US)

(72) Inventors: Steven D. Wehri, Pontiac, IL (US); Eric L. Rogers, El Paso, IL (US); Christopher R. Jones, Washington, IL (US)

(73) Assignee: Caterpillar Inc., Peoria, IL (US)

(21) Appl. No.: 19/084,903

(22) Filed: Mar. 20, 2025

(51) Int. Cl. F02M 55/00; F02M 61/10

(52) U.S. Cl. CPC F02M 55/004; F02M 61/10

(57) ABSTRACT

A fuel injector in an internal combustion engine system includes an injector housing, and a fuel plunger within the injector housing. A clearance is defined between the fuel plunger and the injector housing. The fuel plunger includes a sealing element between the fuel plunger and the injector housing and fluidly sealing the clearance. The fuel injector may be applied in alternative fuel applications limiting migration of fuel from a plunger cavity in the injector housing into other parts of an engine, such as an engine oil system.

### TECHNICAL FIELD

The present disclosure relates generally to pressurizing a fuel for injection in a fuel injector, and more particularly to a fuel plunger configured with a sealing element to limit fuel leakage.

### BACKGROUND

Many modern internal combustion engines are fuel-injected, notably, direct injected in compression-ignition engines. In a typical arrangement, a fuel injector is provided that extends partially into a combustion cylinder in an engine. The fuel injector is supplied with highly pressurized fuel, or pressurizes fuel therein, and injects the same at an injection pressure into the cylinder at a desired injection timing. The fuel is combusted with air to increase temperature and pressure in the cylinder and thereby drive a piston coupled to a crankshaft. Engines of this general type are used in a variety of applications ranging from powering a vehicle powertrain to electric power generation.

Fuel injectors commonly include numerous small and rapidly moving parts, subjected to high fluid pressures, impacts, and otherwise generally harsh and repetitive operation over at least millions of operating cycles. Components of the fuel injector must be capable of withstanding fluid pressures commonly in the hundreds of mega-Pascals (MPa) for many applications. As a result, clearances between parts of the fuel injector can be prone to leakage, and fuel injectors are often designed to permit a certain degree of leakage. One example mechanically actuated fuel injector is known from U.S. Pat. No. 7,950,593B2 to WANG, et al.

### SUMMARY

In one aspect, a fuel injector includes an injector housing having a nozzle with a plurality of spray orifices formed therein, an injection valve movable to open and close the plurality of spray orifices, and a fuel plunger. The fuel plunger includes a first, actuated end, and a second, pumping end. A clearance is defined between the second, pumping end and the injector housing. The fuel injector further includes a sealing element held in compression between the second, pumping end of the fuel plunger and the injector housing and fluidly sealing the clearance.

In another aspect, a fuel plunger for a fuel injector includes an elongate plunger body defining a longitudinal axis extending between a first, actuated end, and a second, pumping end. The first, actuated end includes an enlarged upper head having a planar tappet-contact end surface, and the second, pumping end includes an enlarged lower head having a second end surface. The elongate plunger body also includes a necked-down section extending from the enlarged upper head to the enlarged lower head. The enlarged lower head includes an annular distal head portion including the second end surface, and an annular inward head portion. A seal groove is formed axially between the annular distal head portion and the annular inward head portion and extends circumferentially around the longitudinal axis.

In still another aspect, a method of operating a fuel injector includes advancing a fuel plunger in a fuel injector toward an advanced position in response to rotation of a cam, and pressurizing a fuel to an injection pressure in a plunger cavity in the fuel injector based on the advancing of the fuel plunger. The method further includes biasing a sealing element carried on the fuel plunger outwardly into sealing contact with the injector housing during the advancing of the fuel plunger. The method still further includes limiting migration of pressurized fuel through a clearance defined between the fuel plunger and the injector housing based on the sealing contact.

### BRIEF DESCRIPTION OF DRAWINGS

FIG. 1 is a diagrammatic view of an internal combustion engine system, according to one embodiment;

FIG. 2 is a sectioned side diagrammatic view of a fuel injector, according to one embodiment;

FIG. 3 is a diagrammatic view of a fuel plunger, according to one embodiment;

FIG. 4 is a sectioned diagrammatic view of a fuel plunger, including a detailed enlargement, according to one embodiment; and

FIG. 5 is a partially sectioned diagrammatic view of a sealing element positioned for service in a fuel injector, according to one embodiment.

### DETAILED DESCRIPTION

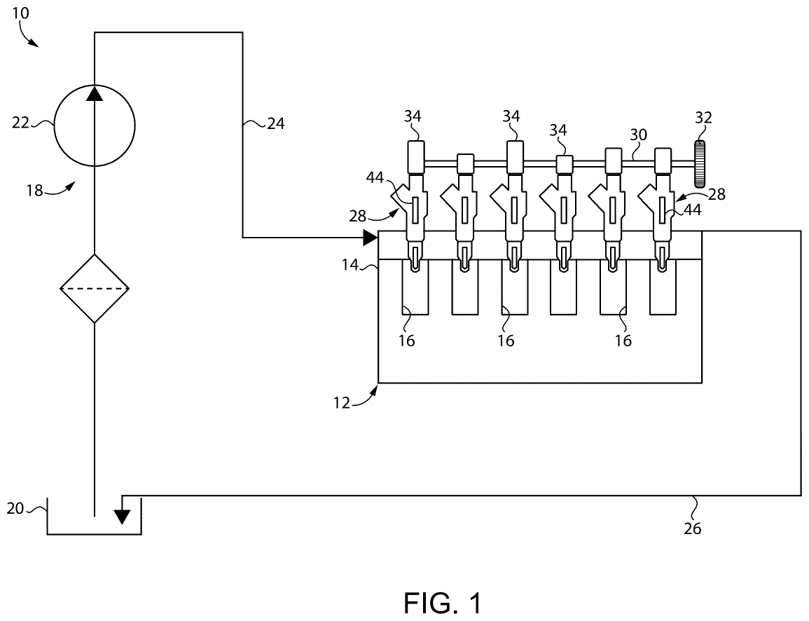

Referring to FIG. 1, there is shown an internal combustion engine system 10, according to one embodiment. Engine system 10 includes an internal combustion engine 12 having an engine housing 14 with a plurality of cylinders 16 formed therein. Cylinders 16 can include any number, in any suitable arrangement such as an inline pattern, a V-pattern, or still another. It will be appreciated that a plurality of pistons will be positioned in cylinders 16 and typically each movable between a top-dead-center position and a bottom-dead-center position, in a generally conventional manner. Engine system 10 may be used in any known application, such as operating a driveline in a land vehicle or a marine vessel, operating a pump, a compressor, or an electrical generator to name a few examples.

Engine system 10 also includes a fuel system 18. Fuel system 18 includes at least one supply of a liquid fuel 20. Fuel supply 20 could include a compression-ignition fuel, such as a diesel distillate fuel, a lower cetane fuel blended with a cetane enhancer, or a variety of so-called alternative fuels such as diesel blended with bio-diesel or otherwise having some degree of bio-content, renewable fuels such as various seed oils, alcohol fuels such as methanol, ethanol, or various blends. Fuel system 18 may be configured to selectively provide multiple fuels, including variable blend ratios in some embodiments.

Engine system 10 will typically be operated as a compression-ignition engine wherein pistons in cylinders 16 increase cylinder pressure and temperature to an auto-ignition threshold. However, the present disclosure is not limited to any particular ignition strategy. Fuel system 18 also includes at least one fuel pump 22 arranged to feed a liquid fuel from fuel supply 20 to engine housing 14 by way of a fuel supply conduit 24. A fuel return conduit 26 conveys fuel from engine housing 14 that is not injected for combustion back to fuel supply 20. In the illustrated embodiment fuel is conveyed through engine housing 13 to a plurality of direct fuel injectors 28. In other arrangements, fuel injectors 28 could be supplied with fuel in a so-called top feed arrangement such that fuel supply does not pass through engine housing 14. Arrangements where fuel injectors 28 include port injectors are also within the scope of the present disclosure.

Fuel injectors 28 may be mechanically actuated to pressurize the fuel to an injection pressure. To this end, engine system 10 further includes a cam gear 32 typically operated by way of an engine geartrain (not shown) and coupled to a camshaft 30. Camshaft 30 includes a plurality of cam lobes 34 that rotate in contact with apparatus associated with fuel injectors 28 to actuate respective fuel plungers 44 therein as further discussed below. Embodiments are also contemplated wherein fuel plungers are provided that pressurize fuel for more than one injector.

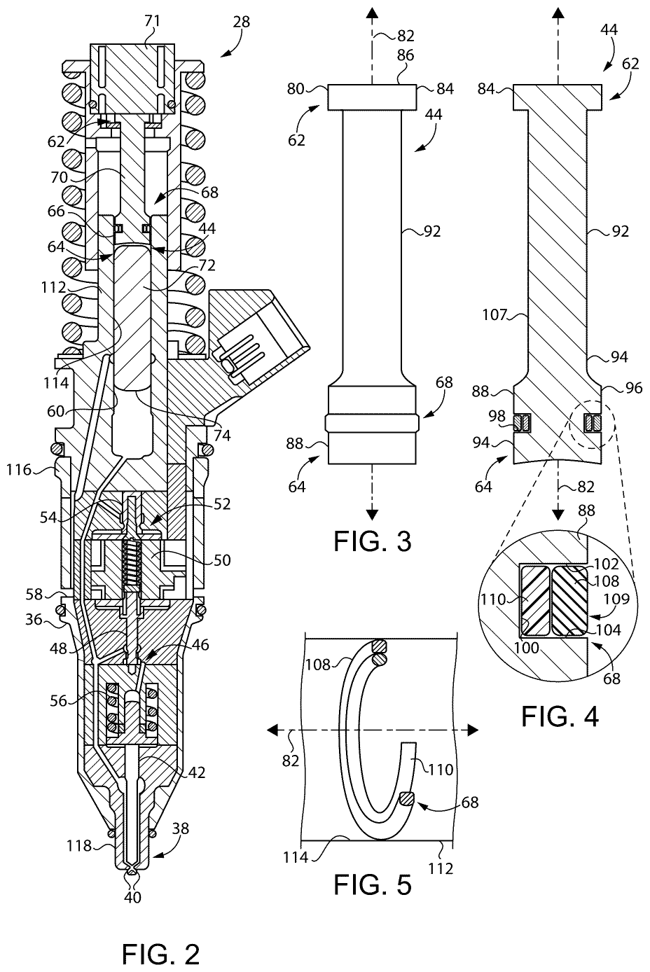

Referring also now to FIG. 2, there are shown features of an example one of fuel injectors 28 hereinafter referred to, at times, in the singular. Fuel injector 28 includes an injector housing 36 having a nozzle 38. Nozzle 38 extends into a corresponding cylinder 16 when fuel injector 28 is installed for service and includes a plurality of spray orifices 40 formed therein. Fuel injector 28 further includes an injection valve 42, such as a needle valve, movable to open and close spray orifices 40 in a generally conventional manner. Fuel injector 28 further includes a fuel plunger 44 as noted above.

Fuel injector 28 may further include an injection control valve assembly 46 having an injection control valve 48 operably coupled to an electrical actuator assembly 50, such as a solenoid actuator assembly including at least one solenoid. Injection control valve 42 may include a closing hydraulic surface 56. Injection control valve 48 may be movable in a generally known manner to vary a fuel pressure, or the pressure of another actuating fluid, acting on closing hydraulic surface 56 to permit opening and closing of injection valve 42. Fuel injector 28 may further include a spill valve assembly 52 having a spill valve 54. Spill valve 54 may be operated by way of electrical actuator assembly 50, including a second solenoid thereof in some embodiments. Spill valve assembly 52 may also be operable in a generally known manner to selectively fluidly connect a plunger cavity 60 formed in injector housing 36 to a low pressure fuel supply such as fuel supply conduit 24, and such that when spill valve 54 is closed advancing of fuel plunger 54 increases a pressure of fuel in plunger cavity 60 to an injection pressure. Injector housing 36 also forms a low pressure fuel inlet 58 that may be connected to fuel supply conduit 24.

Referring also now to FIGS. 3 and 4, there are shown features of fuel plunger 44 in further detail. Fuel injector 44 may include an elongate plunger body 80 defining a longitudinal axis 82 extending between a first, actuated end 62, and a second, pumping end 64. First, actuated end or first end 62 may include an enlarged upper head 84 having a planar tappet-contact end surface 86. A tappet 71 as shown in FIG. 2 contacts end surface 86 to convert rotation of a corresponding cam lobe 34 to a translation of fuel plunger 44 in a generally known manner. Plunger body 80 may further include, upon second, pumping end 64 or second end 64 an enlarged lower head 88. Lower head 88 includes a second end surface 90 which may be non-planar. In the illustrated embodiment, end surface 90 is concave forming a bowl-shape extending circumferentially around longitudinal axis 82. Plunger body 80 may further include a necked-down section 92 extending from enlarged upper head 84 to enlarged lower head 88. Enlarged lower head 88 may include an annular distal head portion 94 including end surface 90, and an annular inward head portion 96.

Returning briefly to FIG. 2, it can be appreciated that fuel plunger 44 may include a two-piece plunger having an upper plunger piece 70 that includes first end 62 and second end 64, and a lower plunger piece 72 including a fuel pumping face 74 exposed to plunger cavity 60 formed in injector housing 36.

A seal groove 98 may be formed axially between distal head portion 94 and inward head portion 96 and extends circumferentially around longitudinal axis 82. In an embodiment, seal groove 98 forms a three-sided profile including a radially inward surface 100, an axially outward surface 104, and an axially inward surface 102. Necked-down section 92 may define a first diameter dimension 107. Seal groove 98 may define a second diameter dimension 106 that is less than first diameter dimension 107.

Fuel plunger 44 may further include a sealing element 68 carried thereon and seated in seal groove 98. Sealing element 68 may be held in compression radially between second, pumping end 64 of fuel plunger 44 and injector housing 36. As depicted in FIG. 2, a clearance 66 may be defined between pumping end 64 and injector housing 36.

Injector housing 36 may also include an injector body piece 112 attached, such as by threading, to a casing 116. Injector body piece 112 defines a plunger bore 114 in which fuel plunger 44 reciprocates. Attachment of injector body piece 112 to casing 116 may clamp components between injector body piece 112 and a tip piece 118 forming spray orifices 40 and situated in casing 116.

FIG. 4 includes a detailed enlargement showing additional features of sealing element 68. It will be recalled sealing element 68 may be held in compression between plunger 44 and injector housing 36. Sealing element 44 may include a compound sealing element having multiple parts in some embodiments. As illustrated, compound sealing element 68 may include an annular radial face seal 108 in sliding contact with injector housing 36 within plunger bore 114. Sealing element 68 may also include a seal energizer 110 held in compression between radial face seal 108 and fuel plunger 44 within seal groove 98. Radial face seal 108 may include a radially outward sealing face 109 that provides axially extending sealing contact with injector housing 36, and slides during service to provide a movable, sealed interface that prevents migration of fuel upward in fuel injector 28 from plunger cavity 60 through clearance 66. In an embodiment, radial face seal 108 is formed of a non-rubber material, such as an elastomeric material or a polytetrafluoroethylene (PTFE) material. Seal energizer 110 may be formed of a rubber material, such as an elastic natural or synthetic rubber. FIG. 5 illustrates sealing element 68 as it might appear in plunger bore 114. Seal energizer 110 may include a conventional O-ring in some embodiments, providing a compressible and resilient backing to radial face seal 108. Radial face seal 108 may be loaf shaped in some embodiments.

### INDUSTRIAL APPLICABILITY

In conventional fuel injectors, notably diesel direct injectors, it has long been recognized that some fuel may leak from a fuel injector during operation. The leaked fuel tends to find its way, at least in part, into an oil system of the associated engine. As discussed above, fuel injectors often pressurize fuel to extremely high pressures, and strategies permitting some leakage of fuel are widespread in the field. Diesel fuel mixed with engine oil tends to vaporize when the engine oil is heated, thus accumulation of diesel fuel in engine oil has previously not been considered highly problematic. In the case of certain alternative fuels, however, vaporization may occur to a lesser extent, if at all. The present disclosure therefore addresses concerns respecting leakage and thereby limits or eliminate entirely migration of leaked fuel into engine oil.

Operating fuel injector 28 can include advancing fuel plunger 44 in fuel injector 28 to an advanced position in response to rotation of a corresponding cam lobe 34. When spill valve 54 is closed, advancing of fuel plunger 44 enables a fuel volume in plunger cavity 60 to be pressurized to an injection pressure. At a desired timing, injection control valve 48 can be opened to relieve a closing hydraulic pressure on closing hydraulic surface 56, such that increased fuel pressure in fuel injector 28 urges injection valve 42 open to start fuel injection. When injection control valve 48 is closed, closing hydraulic pressure upon surface 56 is restored and injection valve 42 closed to end fuel injection. It will be recalled sealing element 68 carried on fuel plunger 44 is biased outwardly into sealing contact with injector housing 36. The sealing contact is of course maintained as fuel plunger 44 reciprocates, limiting or eliminating migration of pressurized fuel through clearance 66.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims. As used herein, the articles “a” and “an” are intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

1. A fuel injector comprising:
an injector housing including a nozzle having a plurality of spray orifices formed therein, an injection valve movable to open and close the plurality of spray orifices, and a fuel plunger;
the fuel plunger including a first, actuated end, and a second, pumping end, and a clearance is defined between the second, pumping end and the injector housing; and
a sealing element held in compression between the second, pumping end of the fuel plunger and the injector housing and fluidly sealing the clearance.

2. The fuel injector of claim 1 wherein the sealing element is carried on the fuel plunger and movable with the fuel plunger between an advanced position and a retracted position.

3. The fuel injector of claim 2 wherein the sealing element includes a compound sealing element.

4. The fuel injector of claim 3 wherein the compound sealing element includes an annular radial face seal in contact with the injector housing, and a seal energizer held in compression between the annular radial face seal and the fuel plunger.

5. The fuel injector of claim 4 wherein the second, pumping end of the fuel plunger includes a seal groove formed therein, and the seal energizer includes an O-ring seated in the seal groove.

6. The fuel injector of claim 4 wherein the annular radial face seal is formed of a first material, and the seal energizer is formed of a second material different from the first material.

7. The fuel injector of claim 2 wherein the fuel plunger is cam-actuated, and the fuel injector further includes a tappet coupled to the first, actuated end of the fuel plunger.

8. The fuel injector of claim 7 wherein the fuel plunger includes a two-piece plunger having an upper plunger piece including the second, pumping end, and a lower plunger piece including a fuel pumping face exposed to a plunger cavity formed in the injector housing.

9. The fuel injector of claim 8 wherein the upper plunger piece includes an enlarged upper head contacted by the tappet, an enlarged lower head, and a necked-down section extending between the enlarged upper head and the enlarged lower head, and the sealing element is carried on the enlarged lower head.

10. A fuel plunger for a fuel injector comprising:
an elongate plunger body defining a longitudinal axis extending between a first, actuated end, and a second, pumping end;
the first, actuated end including an enlarged upper head having a planar tappet-contact end surface, and the second, pumping end including an enlarged lower head having a second end surface, and the elongate plunger body including a necked-down section extending from the enlarged upper head to the enlarged lower head;
the enlarged lower head having an annular distal head portion including the second end surface, and an annular inward head portion; and
a seal groove is formed axially between the annular distal head portion and the annular inward head portion and extends circumferentially around the longitudinal axis.

11. The fuel plunger of claim 10 wherein the seal groove forms a three-sided profile.

12. The fuel plunger of claim 10 wherein the necked-down section defines a first diameter dimension, and the seal groove defines a second diameter dimension that is less than the first diameter dimension.

13. The fuel plunger of claim 10 wherein the second end surface is non-planar.

14. The fuel plunger of claim 10 further comprising a sealing element seated in the seal groove.

15. The fuel plunger of claim 14 wherein the sealing element includes a compound sealing element.

16. The fuel plunger of claim 15 wherein the compound sealing element includes an annular radial face seal in contact with the injector housing, and a seal energizer held in compression between the annular radial face seal and the fuel plunger.

17. The fuel plunger of claim 16 wherein the annular radial face seal is formed of a non-rubber material, and the seal energizer is formed of a rubber material.

18. A method of operating a fuel injector comprising:
advancing a fuel plunger in a fuel injector toward an advanced position in response to rotation of a cam;
pressurizing a fuel to an injection pressure in a plunger cavity in the fuel injector based on the advancing of the fuel plunger;
biasing a sealing element carried on the fuel plunger outwardly into sealing contact with an injector housing of the fuel injector during the advancing of the fuel plunger; and
limiting migration of pressurized fuel through a clearance defined between the fuel plunger and the injector housing based on the sealing contact.

19. The method of claim 18 wherein the fuel plunger includes a two-piece plunger having an upper plunger piece whereon the sealing element is carried, and a lower plunger piece coupled to the upper plunger piece and having a fuel pumping face exposed to the plunger cavity.

20. The method of claim 19 wherein the biasing the sealing element includes biasing an annular radial face seal by way of a seal energizer seated in a seal groove formed in an enlarged head of the upper plunger piece.
